(19) United States
(12) Patent Application Publication
(10) Pub. No.: US 2007/0058646 A1
(43) Pub. Date: Mar. 15, 2007

(54) Device and method for forwarding multicast traffic in a hybrid device

(75) Inventor: Roi Hermoni, Tel Aviv (IL)

Correspondence Address: Siemens Corporation;Intellectual Property Department, 170 Wood Avenue South, Iselin, NJ, 08830, US

(73) Assignee: Siemens Aktiengesellschaft

(21) Appl. No.: 11/212,013

(22) Filed: Aug. 25, 2005

(51) Int. Cl. H04L 12/56

(52) U.S. Cl. 370/401

(57) ABSTRACT

A hybrid device for forwarding traffic in a communication network is provided. According to one embodiment, the hybrid device comprises a layer-2 switch, a multicast forwarding information and a multicast router. The layer-2switch forwards a unicast traffic based on a destination address in the data-link layer within the unicast traffic. The multicast forwarding information may be learned by a subscribe request, an unsubscribe request, and query responses. The multicast router forwards a multicast traffic using a network address within a layer-3 header in the multicast traffic and the multicast forwarding information, the multicast traffic is forwarded toward a user device having requested the traffic via a subscribe request.

### FIELD OF THE INVENTION

The present invention relates to the forwarding of traffic within and between communication network(s), and more particularly, to providing multicast forwarding within a hybrid layer-2 switch.

### BACKGROUND OF THE INVENTION

Routers facilitate communication between devices, such as data processing unit, e.g. computer, in a network or between networks. The router is a hardware device that determines the next network element in which to forward a packet and may include software. A layer-2 switch, also known as a bridge, is a hardware device that uses a data-link layer of the Open Systems Interconnection (OSI) model to forward packets whereas a layer-3 router uses a network layer of the OSI model. The layer-2 switch may also include software. The packet may be for example for Voice over Internet Protocol (VoIP), High Speed Internet, or Broadcast Television and includes a payload and various OSI layers.

A layer-2 switch retrieves a destination address, such as a media access control (MAC) address, from a data-link layer in the packet. The layer-2 switch uses the destination address to forward the packet, typically via a table having a route for the destination address. The layer-2 switch only has to strip off the physical layer to retrieve data-link layer allowing a fast packet forwarding

A layer-3 router retrieves a network address, such as an Internet Protocol (IP) address, from a network layer in the packet. The layer-3 router uses the network address to determine a destination address, typically via a table. The data-link layer header is replaced having the destination address found in the table. The layer-3 router strips off the physical layer and the data-link layer to retrieve the network layer.

When a layer-3 network, such as an IP network, connects to a layer-2 network, it is often required that some processing within the layer-3 network be offloaded to the layer-2 network especially for multicast services. Typically, this is handled by including the layer-3 router within the layer-2 network.

There exists a need to provide and improved way to communicate packets within and between networks.

### SUMMARY OF INVENTION

An aspect of the present invention involves a hybrid device for forwarding traffic in a communication network, comprising a layer-2 switch, a multicast forwarding information, and a multicast router. The layer-2 switch forwards a unicast traffic based on a destination address in the data-link layer within the unicast traffic. The multicast forwarding information learned by a subscribe request and an unsubscribe request. The multicast router forwards a multicast traffic using a network address within a layer-3 header in the multicast traffic and the multicast forwarding information, the multicast traffic is forwarded toward a user device having requested the traffic via a subscribe request.

Another aspect of the present invention involves a hybrid device for forwarding traffic in a communication network, comprising a layer-2 switch, a table, a maximum link cost subnet, a multicast router. The layer-2 switch forwards a unicast traffic received from a layer-3 network, the forwarding based on a destination address in the Media Access Control (MAC) within the unicast traffic. The table having multicast forwarding information learned by an Internet Group Management Protocol (IGMP) requests and responses. The maximum link cost subnet to recognize a multicast traffic. The multicast router forwards the multicast traffic having an Internet Protocol (IP), address having the maximum link cost subnet and the table, the multicast traffic received from the layer-3 network.

Yet another aspect of the present invention involves a method for forwarding a traffic of information by a communication network hybrid device, comprising receiving by a network hybrid device a subscribe request from a user device, updating a table for a multicast router based on the subscribe request, propagating the request to a layer-3 router in a layer-3 network, receiving from the layer-3 router a unicast traffic having a Media Access Control (MAC) address and forwarding the unicast traffic based on the MAC, and receiving from the layer-3 router a multicast traffic having an Internet Protocol (IP) address and forwarding toward the user the multicast traffic device based on the IP address and the table.

### BRIEF DESCRIPTION OF THE DRAWINGS

The above mentioned and other concepts of the present invention will now be described with reference to the drawings of the exemplary and preferred embodiments of the present invention. The illustrated embodiments are intended to illustrate, but not to limit the invention. The drawings contain the following figures, in which like number refer to like parts throughout the description and drawings wherein:

FIG. 1 is an exemplary schematic diagram of a communication system having a layer-3 network and a layer-2 network in accordance to the present invention; and

FIG. 2 is an exemplary schematic diagram of traffic in a communication system having a layer-3 network and a layer-2 network in accordance to the present invention.

### DETAILED DESCRIPTION OF INVENTION

The invention described herein may employ one or more of the following concepts. For example, one concept relates to a hybrid device adapted to route unicast packets based on a layer-2 protocol and multicast packets based on a layer-3 protocol. Another concept relates to traffic types having different subnets. Another concept relates to avoiding sending layer-3 unicast packet from a layer-3 router to a hybrid device. Yet another concept relates to a hybrid device ignoring layer-3 unicast packets.

The present invention is disclosed in terms of an Internet Protocol (IP), other network layer protocols of the Open Systems Interconnection (OSI) model may be used to send packets of data in a network. Also, while the present invention is disclosed in terms of Internet Group Management Protocol (IGMP) other protocols allowing a subscribe request to join a group or an unsubscribe request to unsubscribe from a group may be used, such as IGMP proxy or Protocol Independent Multicast (PIM). While the present invention is disclosed in terms of Digital Subscriber Line (DSL) other communication types such as cable, optical. Also, while the present invention is disclosed in terms of Digital Subscriber Line Access Multiplexer (DSLAM) devices, other multiplexer type devices such as a Cable modem termination system (CMTS). Furthermore, while the present invention is described in terms of subscribing to a Broadband Television (BTV) service, other services that allow a subscription to a group and use multicasting may be used, such as audio and video conferencing.

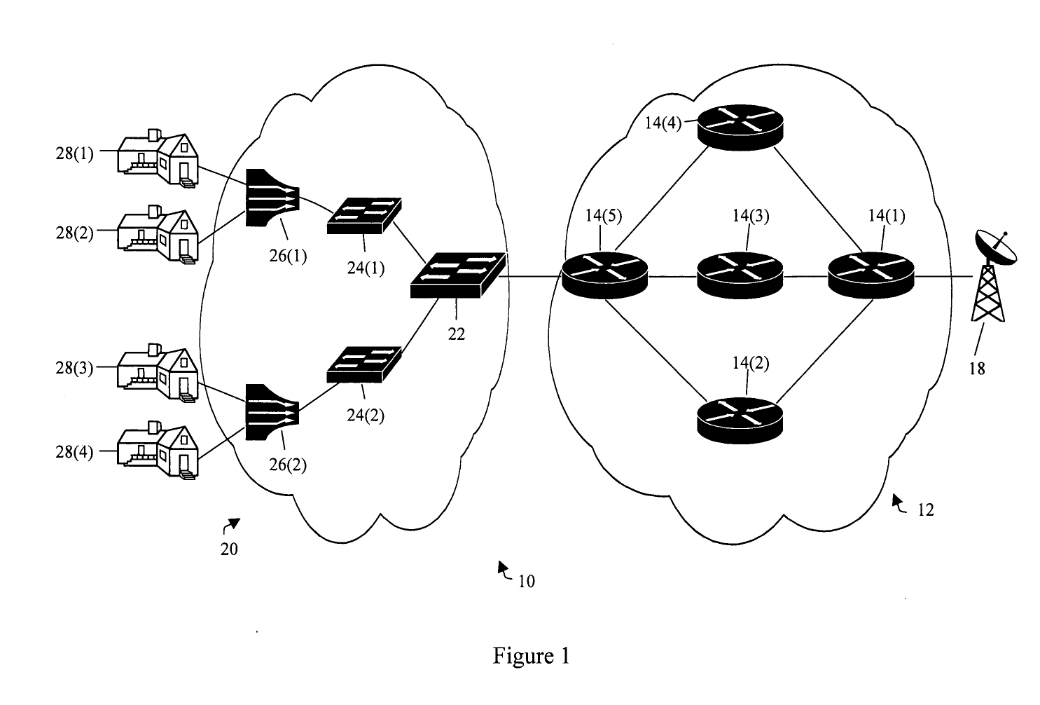

Referring to FIG. 1, a schematic diagram of a communication system 10 is provided. The communication system 10 has a layer-3 network 12, a layer-2 network 20, a traffic source 18, and an end user facility 28.

The layer-3 network 12 has a plurality of layer-3 routers 14 coupled to each other. The terms “couple” and “coupled” refer to any direct or indirect communication between two or more elements in communication system 10, whether or not those elements are in physical contact with one another. In the exemplary topology of the layer-3 network 12, the layer-3 router 14(1) has communication links to layer-3 routers 14(2), 14(3), and 14(4), and network layer-3 router 14(5) has communication links to layer-3 routers 14(4), 14(3), and 14(2). The term “communication link” refers to any system that suitably supports communication between coupled network elements such as wireless, wireline, electrical, optical and combinations thereof, and the like. The layer-3 network 12 is coupled to the traffic source 18 via layer-3 router 14(1). The traffic source 18 is any suitable device that provides traffic to the layer-3 network 12. “Traffic” refers to a packet, a message, streams, or other suitable form(s) of data, voice or combinations thereof. For example, the traffic source 18 may be a satellite dish for communicating traffic having video streams used in BTV. Furthermore, the layer-3 network 12 is coupled to the layer-2 network 20 via the layer-3 router 14(5). The layer-3 router 14(5) is an edge-layer-3 router since it is on the “edge” of the layer-3 network 12 and communicates to a separate network.

In the exemplary illustration of FIG. 1, the layer-2 network 20 has a plurality of DSLAM devices 26, and a plurality of layer-2 switches 24, and a hybrid layer-2 switch 22. The hybrid-layer-2 switch 22 is coupled to the DSLAM device 26 via the layer-2 switch 24. The DSLAM devices 26 are further coupled to an end user facility 28.

An end user facility 28 has a user device capable of requesting traffic from a service. For example, a television (TV) capable of subscribing to BTV, a data processing unit capable of using the Internet, or a phone capable of using Voice over IP (VoIP). Unicast services, such as VoIP and Internet, may have traffic forwarded toward a single user device whereas multicast service, such as BTV, may have traffic forwarded toward multiple user devices. The terms “forwarded toward” refers to sending traffic from a sending point to a receiving point either directly or indirectly and wherein the sending point does not have to originate the traffic and wherein the traffic does not have to end at the receiving point.

The hybrid layer-2 switch 22 is a hardware device that may include software. The hybrid layer-2 switch 22 includes the functionality of a layer-2 switch e.g. the hybrid layer-2 switch 22 forwards traffic based on the MAC address. The hybrid layer-2 switch 22 also includes a multicast router so that the hybrid layer-2 switch 22 can forward multicast traffic based on the IP address, which advantageously may offload traffic for the hybrid layer-3 router 14 without the hybrid layer-2 switch 22 having the high processing overhead of handling the layer-3 unicast traffic. Additionally, the hybrid layer-2 switch 22 learns the multicast forwarding information as described in further detail below.

To request a multicast service the user device issues a subscribe request to subscribe to the service. User devices that subscribe to receive a multicast service are the members of the group. By joining a group, the user device becomes a group member. The subscribe request is propagated up the communication system 10 so that the layer-3 network 12 and hybrid layer-2 switch 22 may learn how to route multicast traffic. The networks 12, 20 keep track of the subscribed user devices in a table.

For example, if an end user prefers to receive channel 3 on a TV at the end user facility 28(1), the TV requests to receive channel 3 by sending an IGMP join request to the layer-2 network 20. Thus the TV joins a group to receive channel 3. The IGMP join request is propagated (the request maybe modified during propagation, including changing to a different protocol, e.g. PIM) up the communication system 10 so that the layer-3 network 12 and hybrid layer-2 switch 22 learns how to route channel 3 traffic.

To stop receiving a multicast service the user device issues an unsubscribe request to unsubscribe from the service. User devices that unsubscribe from multicast are removed from the group membership. The communication system 10 learns forwarding information from the unsubscribe similarly to the subscribe request.

For example, if an end user prefers to change from channel 3 to receive channel 4 on a TV at the end user facility 28(1), the TV requests to unsubscribe from channel 3 via an IGMP leave request. Similarly to the IGMP join request, the IGMP join leave is propagated (the request maybe modified during propagation, including changing to a different protocol, e.g. PIM) up the communication system 10.

Additionally, the hybrid layer-2 switch 22 and the layer-3 network 12 may learn multicast forwarding information via other requests and responses. For example, hybrid layer-2 switch 22 and the layer-3 network 12 may learn multicast forwarding information a response to query request, the query request typically initiated in the layer-3 network 12.

The hybrid layer-2 switch 22 also learns MAC addresses and a corresponding port for which traffic is received. The hybrid layer-2 switch 22 uses the learned MAC addresses to forward subsequent unicast traffic. In contrast, the layer-2 switch 24 learns the MAC addresses and corresponding ports but does not learn how to route multicast traffic.

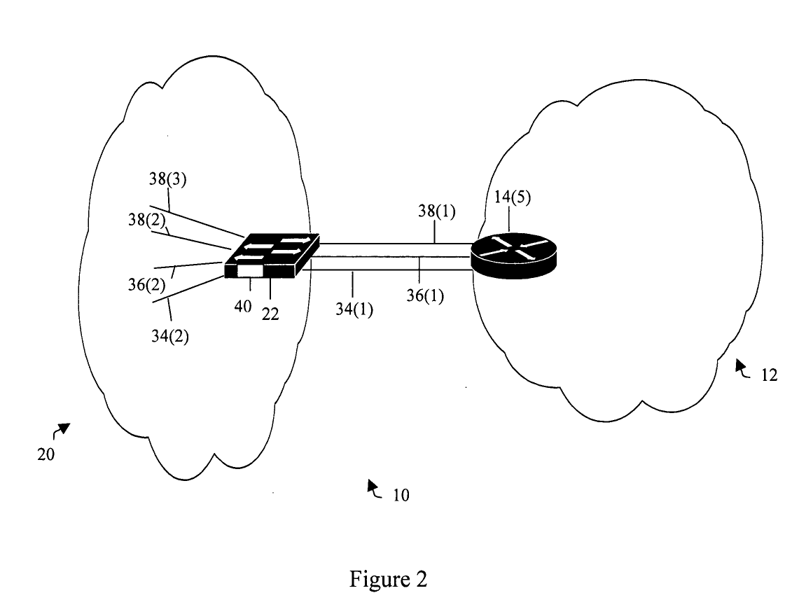

Referring now to FIG. 2, a schematic diagram of traffic 34, 36, 38 in a communication system 10 having a layer-3 network 12 and a layer-2 network 20 in accordance to the present invention is provided. In the exemplary diagram, VoIP traffic 34(1), Internet Protocol traffic 36(1), and BTV 38(1) between the layer-3 router 14(5) and the hybrid layer-2 switch 22 is shown. Although the traffic 34(1), 36(1), 38(1) is shown separately, it may be provided over a single physical layer.

Each traffic type, i.e. VoIP, is provided with a different subnet for forwarding the packets by the hybrid layer-2 switch 22. The hybrid layer-2 switch 22 uses the subnet in the IP address of IP traffic to “recognize” if the traffic is multicast. Unicast traffic 34(1), 36(1) is assigned to subnets allowing the traffic 34(2) 36(2) to be forwarded by the hybrid layer-2 switch 22 using the MAC address as typically done by a layer-2 switch 24. It is preferable to have a maximum link cost associated to a subnet for the multicast traffic 38(1) so that the layer-3 router 14(5) will avoid forwarding the unicast IP traffic using the subnet with the associated maximum link cost. If the hybrid layer-2 switch receives unicast IP traffic using the subnet with the associated maximum link cost it will be discarded. This allows the hybrid layer-2 switch 22 to continue to forward layer-2 traffic and route multicast layer-3 traffic without the overhead of having to route unicast layer-3 traffic.

After the hybrid layer-2 switch 22 receives the multicast traffic 38(1), a Reverse Path Flow (RPF) check relating the flow's source may be performed to determine if the packet should be forwarded or discarded. A RPF check to determine if the multicast traffic 38(1) was from a downstream interface or an upstream interface is done. In relation to the hybrid layer-2 switch 22, a downstream interface is toward the end user facility 28 and the upstream interface is toward the traffic source 18. For example, traffic 34(2) to the hybrid layer-2 switch 22 from the layer-2 switch 24 is from a downstream interface whereas a traffic to the hybrid layer-2 switch 22 from the layer-3 router 14(5) is from an upstream interface. If the RPF check determines the traffic was received from the upstream interface, the hybrid layer-2 switch 22 uses the table 40 having the learned subscriber information to forward the multicast traffic 38(2), 38(3); otherwise, the packet is discarded.

It will be understood by one skilled in the art that only although one tier of layer-2 switches 24 is illustrated in FIG. 1 additional tier(s) may be included. Also, it would be understood that the hybrid layer-2 switch 22 may be used in place of the layer-2 switch 24. Additionally, it would be understood that the layer-3 network 12 has n layer-3 routers 14 having numerous topologies possibilities.

The invention may be embodied in many different forms and may be applied to many different types of networks, protocols, and protocol versions and should not be construed as limited to the embodiments set forth herein. Rather, these embodiments are provided so that this disclosure will be thorough and complete, and will fully convey the scope of the invention to those skilled in the art. Thus, the scope of the invention should be determined based upon the appended claims and their legal equivalents, rather than the specific embodiments described above.

1. A hybrid device for forwarding traffic in a communication network, comprising:
a layer-2 switch forwards a unicast traffic, the forwarding based on a destination address in the data-link layer within the unicast traffic;
a multicast forwarding information learned by a subscribe request and an unsubscribe request; and
a multicast router that forwards a multicast traffic using a network address within a layer-3 header in the multicast traffic and the multicast forwarding information, the multicast traffic is forwarded toward a user device having requested the traffic via a subscribe request.

2. The hybrid device according to claim 1, wherein the multicast traffic is forwarded toward a plurality of user devices having requested the traffic via a subscribe request.

3. The hybrid device according to claim 1, wherein the multicast forwarding information is updated on a query response.

4. The hybrid device according to claim 1, wherein the multicast traffic is recognized based on a subnet in the network address.

5. The hybrid device according to claim 1, wherein layer-3 unicast traffic is discarded.

6. The hybrid device according to claim 1, wherein a Reverse Path Flow check is done on the multicast traffic.

7. The hybrid device according to claim 1, wherein the destination address is a Media Access Control (MAC) address.

8. The hybrid device according to claim 1, wherein the network address is a Internet Protocol IP) address

9. A hybrid device for forwarding traffic in a communication network, comprising:
a layer-2 switch that forwards a unicast traffic received from a layer-3 network, the forwarding based on a destination address in the Media Access Control (MAC) within the unicast traffic;
a table having multicast forwarding information learned by a Internet Group Management Protocol (IGMP) requests and responses;
a maximum link cost subnet to recognize a multicast traffic; and
a multicast router that forwards the multicast traffic having an Internet Protocol (IP) address having the maximum link cost subnet and the table, the multicast traffic received from the layer-3 network.

10. The hybrid device according to claim 9, wherein a Reverse Path Flow check is done on the multicast traffic.

11. The hybrid device according to claim 9, wherein the traffic is discarded if received from a downstream link.

12. A method for forwarding a traffic of information by a communication network hybrid device, comprising:
receiving by a network hybrid device a subscribe request from a user device;
updating a table for a multicast router based on the subscribe request;
propagating the request to a layer-3 router in a layer-3 network;
receiving from the layer-3 router a unicast traffic having a Media Access Control (MAC) address and forwarding the unicast traffic based on the MAC; and
receiving from the layer-3 router a multicast traffic having an Internet Protocol (IP) address and forwarding toward the user device the multicast traffic based on the IP address and the table.

13. The method according to claim 12, wherein the IP address has a subnet associated to a maximum link cost

14. The method according to claim 12, wherein prior to forwarding the multicast traffic a Reverse Path Check (RPC) is done and if the multicast traffic is forwarded when the RPC indicates that the received multicast traffic was from an upstream link.

15. The method according to claim 12, further comprising:
receiving a request to unsubscribe from a subscriber and updating the table, and propagating the request to a layer-3 router in a layer-3 network.
